(19) United States
(12) Patent Application Publication
(10) Pub. No.: US 2010/0316831 A1
(43) Pub. Date: Dec. 16, 2010

(54) INFORMATION RECORDING AND REPRODUCING DEVICE

(76) Inventors: Kohichi Kubo, Yokohama-shi (JP); Chikayoshi Kamata, Kawasaki-shi (JP); Takayuki Tsukamoto, Kawasaki-shi (JP); Shinya Aoki, Yokohama-shi (JP); Takahiro Hirai, Yokohama-shi (JP); Toshiro Hiraoka, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/859,911

(22) Filed: Aug. 20, 2010

Related U.S. Application Data
(63) Continuation of application No. PCT/JP08/55001, filed on Mar. 18, 2008.

(51) Int. Cl. B32B 3/02

(52) U.S. Cl. 428/64.4

(57) ABSTRACT

According to one embodiment, an information recording and reproducing device includes a resistive layer directly or indirectly added to a recording layer and having electric resistivity larger than electric resistivity in the low-resistance state of the recording layer. A first compound contained in the recording layer comprises a composite compound includes two or more kinds of cationic elements, at least one of the two or more kinds of cationic elements is a transition element having a d orbit filled incompletely with electrons, a shortest distance between cationic elements adjacent to each other is 0.32 nm or less.

### CROSS-REFERENCE TO RELATED APPLICATION

This is a Continuation Application of PCT Application No. PCT/JP2008/055001, filed Mar. 18, 2008, which was published under PCT Article 21(2) in Japanese.

### FIELD

The present invention relates to a high-recording-density information recording and reproducing device.

### BACKGROUND

Recently a demand for a compact, large-capacity, nonvolatile memory has been expanding rapidly with the worldwide spread of compact mobile devices and the substantial progress of high-speed information transmission network. Among others, in a NAND type flash memory and a compact HDD (Hard Disk Drive), recording density has been rapidly improved to form a large market.

Under these situations, there have been proposed some ideas of novel memories that aim to considerably exceed a limit of the recording density.

For example, in a PCRAM (phase-change memory), a material that can take two states of an amorphous state (on) and a crystalline state (off) is used as a recording material, and a principle in which data is recorded while the two states are correlated with binary data of “0” and “1” is adopted.

For example, the amorphous state is produced by applying a large power pulse to the recording material, and the crystalline state is produced by applying a small power pulse to the recording material, thereby performing write/erase.

A small read current is passed through the recording material to such an extent that the write/erase is not performed, and an electric resistance of the recording material is measured, thereby performing read. A resistance value of the recording material in the amorphous state is larger than that of the recording material in the crystalline state, and a ratio of the resistance values is about 10³.

The most distinctive feature of the PCRAM is that it is operated even if an element size is reduced to about 10 nm. In this case, because the recording density of about 10 Tbpsi (Terabit per square inch) can be realized, the PCRAM is one of candidates for the high-recording-density memory (for example, see T. Gotoh, K. Sugawara and K. Tanaka, Jpn. J. Appl. Phys., 43, 6B, 2004, L818).

Further, aside from the PCRAM, there has been proposed a novel memory having an operation principle very similar to that of the PCRAM (for example, see A. Sawa, T. Fuji, M. Kawasaki and Y. Tokura, Appl. Phys. Lett., 85, 18, 4073 (2004)).

According to the report, nickel oxide is a representative example of the recording material in which the data is recorded, and the large power pulse and the small power pulse are used in the write/erase similarly to the PCRAM. In this case, there is reported an advantage that power consumption is reduced in the write/erase compared with the PCRAM.

Although an operation mechanism of the novel memory has not been elucidated yet, reproducibility thereof has been confirmed, and thus the novel memory is expected to be another candidate for the high-recording-density memory. Some groups are now trying to elucidate the operation mechanism.

There has been also proposed a MEMS memory in which a MEMS (Micro Electro Mechanical Systems) technology is used (for example, see P. Vettiger, G. Cross, M. Despont, U. Drechsler, U. Durig, B. Gotsmann, W. Haberle, M. A. Lants, H. E. Rothuizen, R. Stutz and G. K. Binnig, IEEE Trans, Nanotechnology 1, 39 (2002)).

Particularly, the MEMS memory called millipede has a structure in which plural cantilevers formed into an array shape and a recording medium onto which an organic substance is applied face each other, and a probe at a leading end of the cantilever is in contact with the recording medium at a moderate pressure.

A temperature of a heater added to the probe is selectively controlled, thereby performing the write. That is, when the temperature of the heater is raised, the recording medium is softened, and the probe sinks in the recording medium to form a dent in the recording medium.

While a current is passed through the probe such an extent that the recording medium is not softened, a surface of the recording medium is scanned with the probe, thereby performing the read. When the probe falls in the dent of the recording medium, the temperature of the probe is lowered to increase the resistance value of the heater, so that the data can be sensed by reading the change of the resistance value.

The most distinctive feature of the MEMS memory such as the millipede is that the recording density can dramatically be improved because there is no need to provide an interconnection in each recording portion in which the bit data is recorded. Currently the recording density of about 1 Tbpsi has been already achieved (for example, see P. Vettiger, T. Albrecht, M. Despont, U. Drechsler, U. Durig, B. Gotsmann, D. Jubin, W. Haberle, M. A. Lants, H. E. Rothuizen, R. Stutz, D. Wiesmann and G. K. Binnig, P. Bachtold, G. Cherubini, C. Hagleitner, T. Loeliger, A. Pantazi, H. Pozidis and E. Eleftheriou, in Technical Digest, IEDM03 pp. 763-766).

Recently, after the announcement of the millipede, the MEMS technology and the new recording principle are combined to try to achieve great improvements of the power consumption, recording density, and an operation speed.

For example, there has been proposed a method, in which a ferroelectric layer is provided in the recording medium, and dielectric polarization is created in the ferroelectric layer by applying a voltage to the recording medium, thereby performing the data recording. According to the method, it is theoretically predicted that an interval (minimum recording unit) between recording portions in which the bit data is recorded can be brought close to a unit cell level of a crystal.

Assuming that the recording minimum unit is one unit cell of the crystal of the ferroelectric layer, the recording density becomes a huge value of about 4 Pbpsi (Peta bit per square inch).

Recently, practical realization of the novel memory proceeds considerably by a proposal of a read method in which an SNDM (Scanning Nonlinear Dielectric Microscope) is used (for example, see A. Onoue, S. Hashimoto, Y. Chu, Mat. Sci. Eng. B120, 130 (2005)).

### BRIEF SUMMARY

The present invention provides a nonvolatile information recording and reproducing device having the high recording density and the low power consumption.

In an information recording and reproducing device according to the invention, a first compound contained in a recording layer comprises a composite compound comprising two or more kinds of cationic elements, at least one of the two or more kinds of cationic elements is a transition element having a d orbit filled incompletely with electrons, a shortest distance between cationic elements adjacent to each other is 0.32 nm or less, and the recording layer has at least two values of a low-resistance state and a high-resistance state by a phase change. The information recording and reproducing device of the invention comprises a resistive layer directly or indirectly added to the recording layer and having electric resistivity larger than electric resistivity in the low-resistance state of the recording layer.

According to the invention, the high-recording-density, low-power-consumption nonvolatile information recording and reproducing device can be implemented.

### BRIEF DESCRIPTION OF THE DRAWINGS

FIGS. 1 to 9 are views, each illustrating a recording principle.

FIG. 10 is a view illustrating a probe type solid-state memory.

FIG. 11 is a view illustrating segmentation of a recording medium.

FIG. 12 is a view illustrating a state during recording.

FIG. 13 is a view illustrating a recording operation.

FIG. 14 is a view illustrating a reproducing operation.

FIG. 15 is a view illustrating a recording operation.

FIG. 16 is a view illustrating a reproducing operation.

FIG. 17 is a view illustrating a cross-point type solid-state memory.

FIG. 18 is a view illustrating a structure of a memory cell array.

FIG. 19 is a view illustrating a structure of a memory cell.

FIGS. 20 and 21 are views, each illustrating a structure of the memory cell array.

FIG. 22 is a view illustrating an example of application to a flash memory.

FIG. 23 is a circuit diagram illustrating a NAND cell unit.

FIGS. 24 to 26 are views, each illustrating a structure of the NAND cell unit.

FIG. 27 is a circuit diagram illustrating a NOR cell.

FIG. 28 is a view illustrating a structure of the NOR cell.

FIG. 29 is a circuit diagram illustrating a two-transistor cell unit.

FIGS. 30 and 31 are views, each illustrating a structure of the two-transistor cell unit.

### DETAILED DESCRIPTION

The best mode for carrying out the invention will be described below with reference to the drawings.

### 1. Outline

The distinctive feature of the information recording and reproducing device of the invention is that a resistive layer is directly or indirectly added to a recording layer. The recording layer has at least two values of a low-resistance state and a high-resistance state, which are obtained by the phase change. The resistive layer has electric resistivity larger than electric resistivity in the low-resistance state of the recording layer, and acts as a heat source during the resistance change (during setting/resetting) of the recording layer.

The direct addition means that the recording layer and the resistive layer are in direct contact with each other. The direct addition structure is preferably adopted. The indirect addition means that an interfacial layer exists between the recording layer and the resistive layer. For example, the interfacial layer may be a layer positively formed to establish coherency (such as orientation and crystalline structure) between the recording layer and the resistive layer, or an extremely thin layer such as an oxidation layer inevitably formed through a process.

The recording layer contains a first compound comprising a composite compound having two or more kinds of cationic elements, at least one of the two or more kinds of the cationic elements is a transition element having a d orbit incompletely filled with electrons, and the shortest distance between the cationic elements adjacent to each other is 0.32 nm or less. The recording layer may further contain a second compound in addition to the first compound, the second compound comprising at least one kind of transition element, having a vacant site in which one of the two or more kinds of the cationic elements can be accommodated, and being in contact with the first compound.

An effect obtained by adding the resistive layer to the recording layer will be described along with an operation principle.

An initial state of the recording layer is the insulator, but some cationic elements existing in the recording layer move onto a cathode side by providing a potential difference between both ends of the recording layer. As a result, the cationic elements collect on the cathode side, and the cationic elements receive electrons from the cathode, thereby depositing metal. On the other hand, because a proportion of the cationic element relatively becomes smaller than that of the anion element on the anode side, the compound becomes the high oxidation state by emitting electrons to the anode.

This is a so-called setting operation. The above-described change can be treated as a kind of electrolysis reaction. In this case, generally p-type carriers can be considered to have been injected into the compound in the high oxidation state, and the compound changes to a low-resistance material.

When current is passed through the low-resistance material again, because of the low resistance, large current is passed even if the potential difference is low. At this time, Joule heat is generated in the recording layer, and a temperature is raised in the recording layer.

In the setting operation, the oxidizing agent and the reducing agent are separately generated at both ends of the electrode. This time, because of the high temperature, a reverse reaction is generated, the compound returns to the insulator state of the pre-setting. This is a resetting operation. The power consumption of the resistance change type solid-state memory having the above-described operation principle increases during the resetting in which the recording layer changes from the low-resistance state to the high-resistance state.

Therefore, in the invention, the resistive layer is added to the recording layer such that a current pathway does not have low resistance more than necessary even in the resetting, thereby reducing the power consumption

In order to effectively obtain the effect, the resistive layer has electric resistivity larger than that in the low-resistance state of the recording layer. More preferably the resistive layer has the electric resistivity larger than that of the recording layer by at least one order of magnitude, for example, the resistive layer has the electric resistivity larger than 1×10⁻³ Ωcm.

The following compounds can be cited as an example of the material for the resistive layer.
Compound expressed by chemical formula: AOₓN_{y}

Where A is at least one element selected from the group consisting of B, C, Al, Y, Ln, Si, Ti, Zr, Hf, V, Nb, Ta, Cr, Mo, and W, Ln is a lanthanoid element, and a molar ratio satisfies 0≦x≦2.5 and 0.1<y≦2.
One of DLC (Diamond-Like Carbon), B₄C, and BN

Preferably the resistive layer is in the amorphous state.

Preferably the resistive layer is made of a stable material whose resistance value does not change by the application of the voltage during the setting/resetting. When many elements having divalence or univalence are contained in the compound, ions move by an influence of an electric field to create the phase change, thereby generating the resistance change. Accordingly, for the resistive layer, the valence of cation is set to three or more, and nitrogen that is a trivalent ion having a percentage of at least 10% of cation is contained as the anion in addition to oxygen.

The following point is considered when the current is passed through the resistive layer.

When a trace amount of F element ranging from 10 ppm to 1000 ppm is added to the material contained in the resistive layer, a stable insulating property of the resistive layer is effectively maintained because an effect of effectively eliminating a dangling bond is generated.

Generally a phenomenon that is far from a macro physical phenomenon emerges with progress of fine element, and a mechanism that generates the Joule heat is regarded as one of the phenomena.

The resistive layer is made as thin as possible because the Joule heat generated in the resistive layer is efficiently provided to the recording layer. For example, the resistive layer has the thickness of 50 nm or less, more preferably the thickness ranges from 1 nm to 2 nm.

When the resistive layer is thinned to a level of electron mean free path, a scattering probability of electrons passing through the resistive layer decreases, but a proportion of electrons passing through the resistive layer by a tunneling phenomenon increases instead. In this case, a region where electrons lose energy to produce heat is not the inside of the resistive layer, but a point at which the electrons pass through the resistive layer.

Accordingly, from the viewpoint of electron flow, the recording layer is disposed downstream of the resistive layer such that electrons lose the energy in the recording layer. That is, the resistive layer is disposed on the cathode side of the recording layer in applying the voltage to the recording layer.

In order that electrons do not lose the energy after passing through the resistive layer and the recording layer, the electron mean free path in the resistive layer is set shorter than the thickness of the resistive layer. As a result, the electrons lose the energy in the recording layer immediately after passing through the resistive layer.

Therefore, preferably the resistive layer is made of an amorphous material.

The state of the recording layer is read by passing pulse current through the recording layer, and the recording layer is made of a material in which the resistance change is not caused by the pulse current.

The invention is effectively applied to a solid-state memory such as ReRAM in which the recording layer comprises the resistance-change element, a solid-state memory such as PCRAM in which the recording layer comprises the phase-change element, a probe type solid-state memory in which the resistance-change element or the phase-change element is used as the recording element, and the like.

When the resistive layer satisfying the above-described conditions is added to the recording layer, in principle, the recording density of the information recording and reproducing device can achieve the Pbpsi (Peta bit per square inch) level and the power consumption can considerably be reduced.

### 2. Basic Principle of Recording/Reproduction

A basic principle of the information recording/reproduction in the information recording and reproducing device according to an example of the invention will be described.

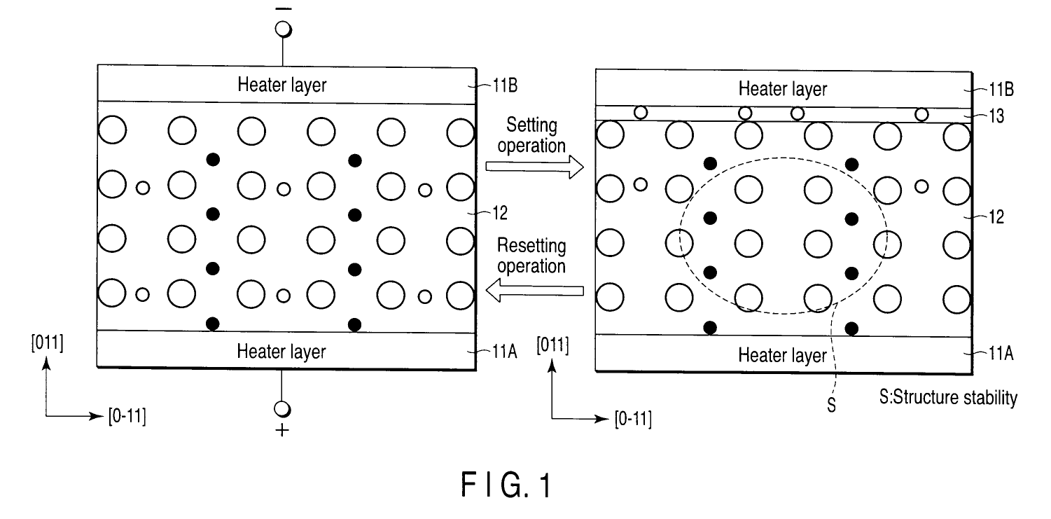

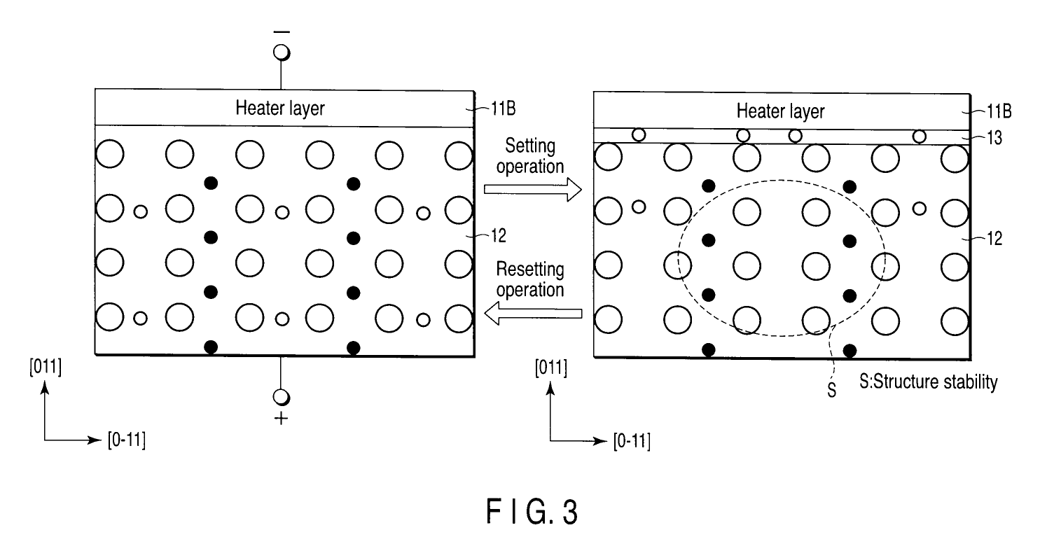

FIGS. 1 and 3 illustrate a structure of a recording portion.

The numerals 11A and 11B designate heater layers (resistive layers), and the numeral 12 designates a recording layer. The heater layers 11A and 11B are disposed at both ends or at one end of the recording layer 12.

FIGS. 1 and 3 illustrate only minimum necessary requirements of the invention. For example, a buffer layer or a protective layer may further be added adjacent to the heater layers 11A and 11B. The stacked structure comprising the heater layers 11A and 11B and the recording layer 12 is sandwiched between two electrode layers (lower electrode and upper electrode).

A small white circle in the recording layer 12 indicates a diffusion ion A, and a small black circle indicates a transition element ion M. A large white circle indicates an anion X.

When the voltage is applied to the recording layer 12 to generate a potential gradient in the recording layer 12, some diffusion ions move in the crystal. Therefore, in the example of the invention, the initial state of the recording layer 12 is set to the insulator (high-resistance state), and the phase change of the recording layer 12 is induced by the potential gradient to provide the conductivity (low-resistance state) to the recording layer 12, thereby performing the information recording.

In the description, the high-resistance state is defined as the reset state, and the low-resistance state is defined as the set state. However, the definition is made for the sake of convenience, and occasionally the reverse case to the definition, the case in which the low-resistance state becomes the reset (initial) state while the high-resistance state becomes the set state, occurs depending on material selection or a producing method. Obviously the reverse case is also included in the scope of the invention.

First, for example, the state in which the potential on the side of the heater layer 11B is relatively lower than the potential on the side of the heater layer 11A is produced. When the side of the heater layer 11A is set to the fixed potential (for example, ground potential), the side of the heater layer 11B is set to the negative potential.

At this point, some diffusion ions in the recording layer 12 move onto the side of the heater layer 11B (cathode side), whereby the number of diffusion ions in the recording layer (crystal) 12 decreases relative to the number of anions. The diffusion ions having moved onto the side of the heater layer 11B receive electrons from the electrode layer (not illustrated), and form a metallic layer 13 to be deposited as the metal.

The anions become excessive in the recording layer 12 to increase the valence of transition element ion in the recording layer 12. That is, because the recording layer 12 has the electron conductivity due to the carrier injection, the information recording (setting operation) is completed.

The pulse current is passed through the recording layer 12 to detect the resistance value of the recording layer 12, thereby easily performing the information reproduction. However, it is necessary that the pulse current be set to a minute value to an extent that the material of the recording layer 12 does not create the phase change.

The above-described process is a kind of electrolysis, and it can be considered that the oxidizing agent is generated by electrochemical oxidation on the side of the heater layer 11A (anode side) while the reducing agent is generated by electrochemical reduction on the side of the heater layer 11B (cathode side) 13.

Therefore, in order to return the information recording state (low-resistance state) to the initial state (high-resistance state), the recording layer 12 is subjected to the joule heating by the large current pulse to promote the redox reaction of the recording layer 12. That is, the recording layer 12 returns to the insulator (resetting operation) by residual heat after cutoff of the large current pulse.

However, in order to put the operation principle into practical use, it is necessary not to cause the resetting operation at room temperature (it is necessary to secure a sufficiently long retention time), and it is necessary that the power consumption be sufficiently small in the resetting operation.

The former can be dealt with by decreasing the coordination number of the diffusion ion (ideally 2 or less), increasing the valence of diffusion ion to 2 or more, or increasing the valence of anion (ideally 3 or more).

The latter can be dealt with in such a manner that the valence of diffusion ion is decreased to 2 or less so as not to cause crystal breakage, and that a material having many moving pathways of the diffusion ions moving in the recording layer (crystal) 12 is found.

The material described in the outline may be used in the recording layer 12.

Because the oxidizing agent is generated on the side of the heater layer 11A (anode side) 11 after the setting operation, the electrode layer provided on the side of the heater layer 11A is made of a hardly-oxidizable material (such as conductive nitride and conductive oxide).

The electrode layer on the side of the heater layer 11A is made of a material having no ion conductivity.

The material having no ion conductivity can be cited as follows. Among others, LaNiO₃ is the most suitable material from the viewpoint of comprehensive performance including good electric conductivity and the like.
MN

M contains at least one element selected from the group consisting of Ti, Zr, Hf, V, Nb, and Ta. N is nitrogen.
MOₓ

M contains at least one element selected from the group consisting of Ti, V, Cr, Mn, Fe, Co, Ni, Cu, Zr, Nb, Mo, Ru, Rh, Pd, Ag, Hf, Ta, W, Re, Ir, Os, and Pt. A molar ratio satisfies 1≦x≦4.
AMO₃

A contains at least one element selected from the group consisting of La, K, Ca, Sr, Ba, and Ln (Lanthanide).

M contains at least one element selected from the group consisting of Ti, V, Cr, Mn, Fe, Co, Ni, Cu, Zr, Nb, Mo, Ru, Rh, Pd, Ag, Hf, Ta, W, Re, Ir, Os, and Pt.

O is oxygen.
B₂MO₄

B contains at least one element selected from the group consisting of K, Ca, Sr, Ba, and Ln (Lanthanide).

M contains at least one element selected from the group consisting of Ti, V, Cr, Mn, Fe, Co, Ni, Cu, Zr, Nb, Mo, Ru, Rh, Pd, Ag, Hf, Ta, W, Re, Ir, Os, and Pt.

O is oxygen.

Because the reducing agent is generated on the side of the heater layer 11B (cathode side) after the setting operation, the electrode layer provided on the side of the heater layer 11B is made of a material that has a function of preventing the recording layer 12 from reacting with atmosphere.

Examples of such material include semiconductor such as amorphous carbon, diamond-like carbon, and SnO₂.

The electrode layer on the side of the heater layer 11B may act as the protective layer that protects the recording layer 12, or the protective layer may be provided instead of the electrode layer. In such cases, the protective layer may be made of either the insulator or the conductor.

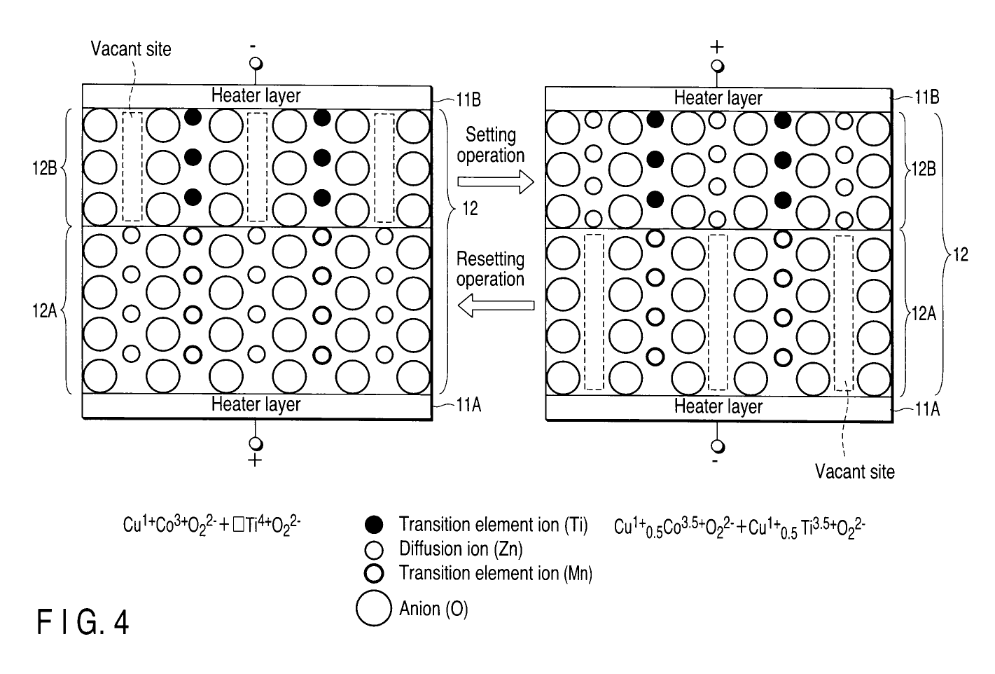

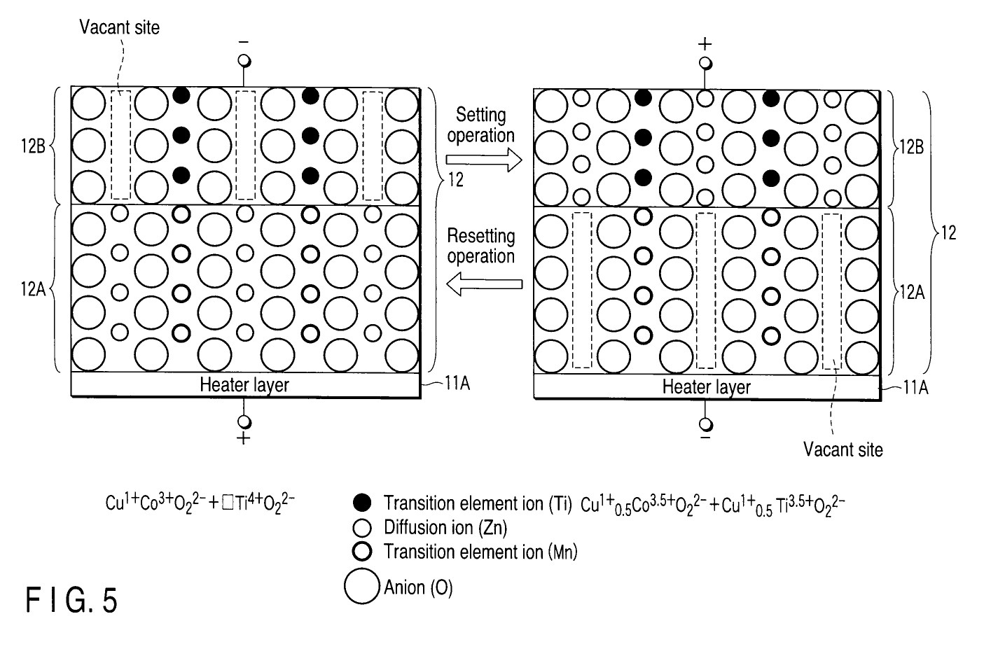

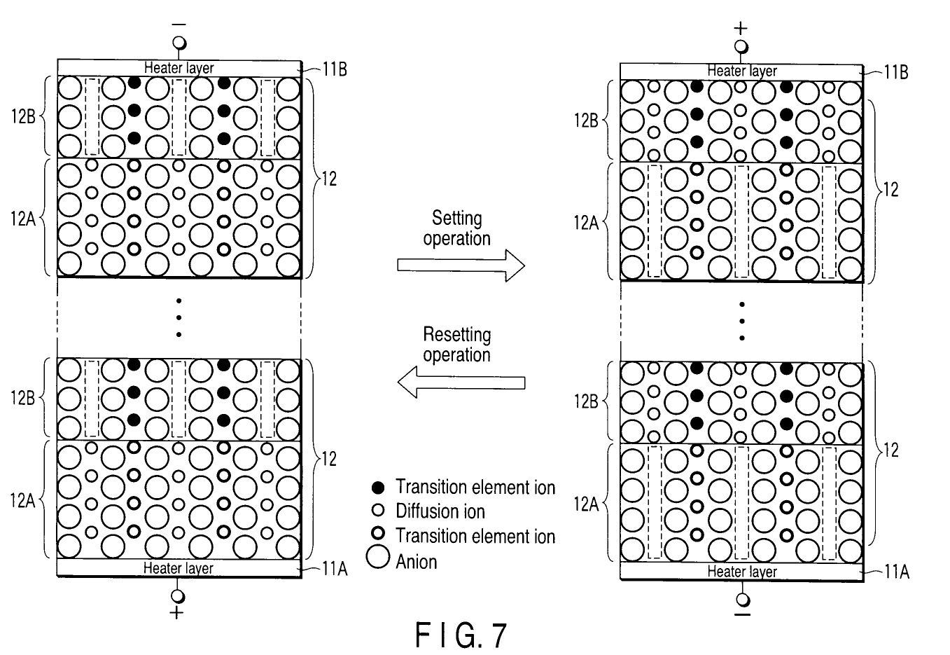

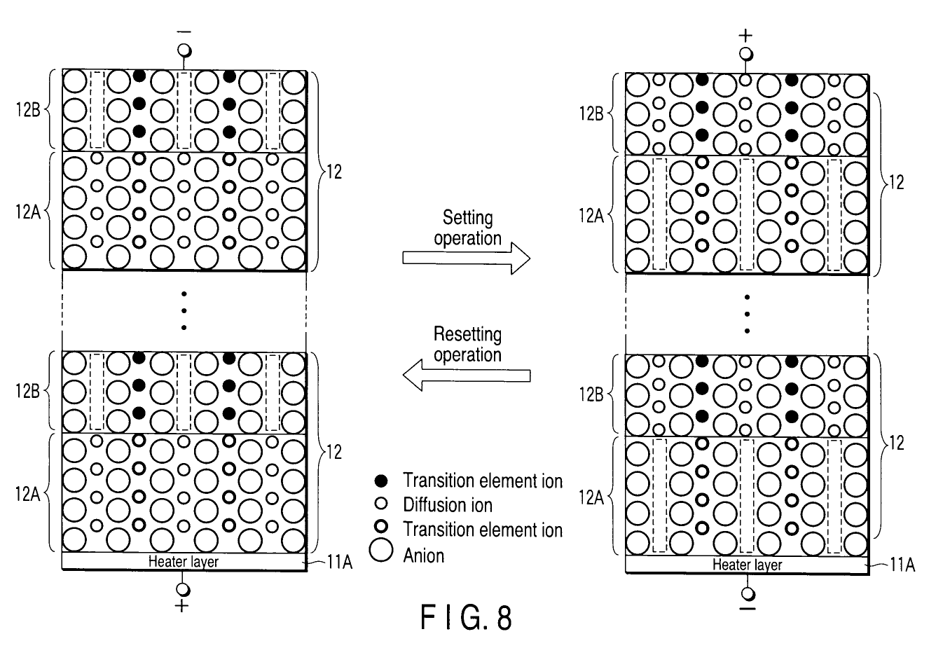

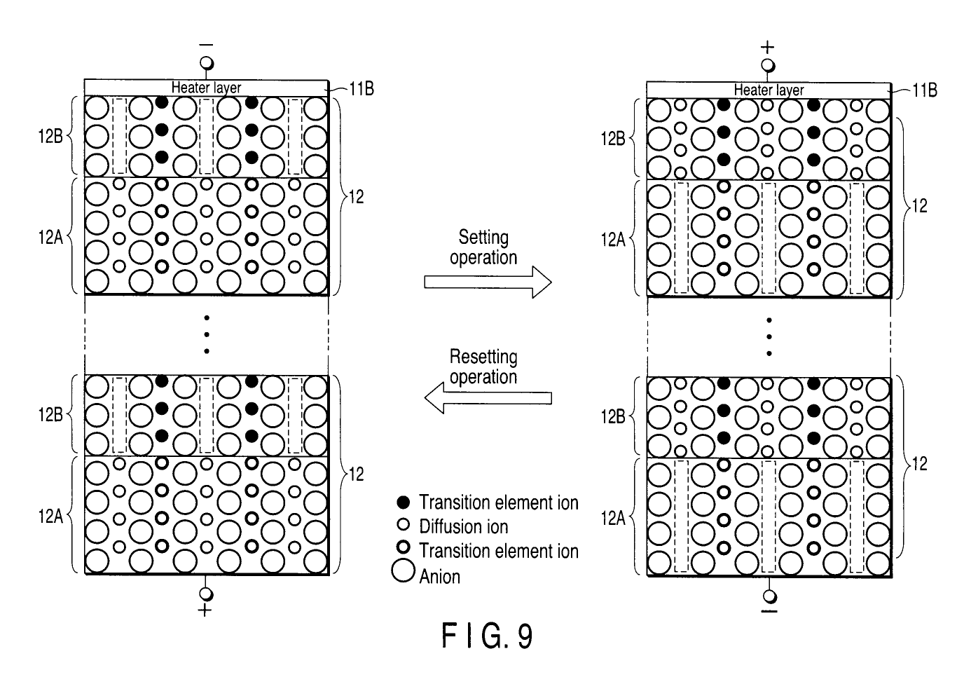

As illustrated in FIGS. 4 to 6, a second compound 12B may be stacked on a recording layer (first compound) 12A. As illustrated in FIGS. 7 to 9, the plural recording layers 12 comprising the first and second compounds 12A and 12B may be stacked.

The distinctive feature of the second compound 12B is that it has a vacant site α.

Assuming that □ is the vacant site α, the second compound 12B is expressed by the following formulas.
Chemical formula: □ₓMZ₂

Where □ is a vacant site in which the X is accommodated, M contains at least one element selected from the group consisting of Ti, V, Cr, Mn, Fe, Co, Ni, Nb, Ta, Mo, W, Re, Ru, and Rh, Z contains at least one element selected from the group consisting of O, S, Se, N, Cl, Br, and I, and a molar ratio satisfies 0.3≦x≦1.
Chemical formula: □ₓMZ₃

Where □ is a vacant site in which the X is accommodated, M contains at least one element selected from the group consisting of Ti, V, Cr, Mn, Fe, Co, Ni, Nb, Ta, Mo, W, Re, Ru, and Rh, Z contains at least one element selected from the group consisting of O, S, Se, N, Cl, Br, and I, and a molar ratio satisfies 1≦x≦2.
Chemical formula: □ₓMZ₄

Where □ is a vacant site in which the X is accommodated, M contains at least one element selected from the group consisting of Ti, V, Cr, Mn, Fe, Co, Ni, Nb, Ta, Mo, W, Re, Ru, and Rh, Z contains at least one element selected from the group consisting of O, S, Se, N, Cl, Br, and I, and a molar ratio satisfies 1≦x≦2.
Chemical formula: □ₓMPO_{z}

Where □ is a vacant site in which the X is accommodated, M contains at least one element selected from the group consisting of Ti, V, Cr, Mn, Fe, Co, Ni, Nb, Ta, Mo, W, Re, Ru, and Rh, P is a phosphorous element, O is an oxygen element, and a molar ratio satisfies 0.3≦x≦3 and 4≦z≦6.

The above-described second compound 12B has the functions of storing the ion discharged from the first compound 12A, smoothes the ion movement, and realizes the improvement of reversibility.

Preferably the second compound 12B has one of a hollandite structure, a ramsdellite structure, an anatase structure, a brookite structure, a pyrolusite structure, a ReO₃ structure, a MoO_{1.5}PO₄ structure, a TiO_{0.5}PO₄ structure, a FePO₄ structure, a PMnO₂ structure, a yMnO₂ structure, and a XMnO₂ structure.

Preferably a C-axis of a crystal of the recording layer 12 is orientated in parallel with a film surface or in a range within 45° relative to a horizontal direction. The resistive layers 11A and 11B are added to the recording layer 12. The resistive layers 11A and 11B may also act as the protective layer or the electrode layer.

For example, the resistive layers 11A and 11B are made of materials expressed by the following formulas.
Compound expressed by chemical formula: AOₓN_{y}

Where A is at least one element selected from the group consisting of B, C, Al, Y, Ln, Si, Ti, Zr, Hf, V, Nb, Ta, Cr, Mo, and W, Ln is a lanthanoid element, and a molar ratio satisfies 0≦x≦2.5 and 0.1<y≦2.
One of DLC (Diamond-Like Carbon), B₄C, and BN

Preferably the resistive layers 11A and 11B are disposed on the anode side of the recording layer 12, and preferably in the amorphous state.

### 3. Embodiments

Some embodiments that are expected to be the best will be described below.

The case in which an example of the invention is applied to a probe type solid-state memory and the case in which an example of the invention is applied to a cross-point type solid-state memory will be described below.

(1) Probe Type Solid-State Memory

A. Structure

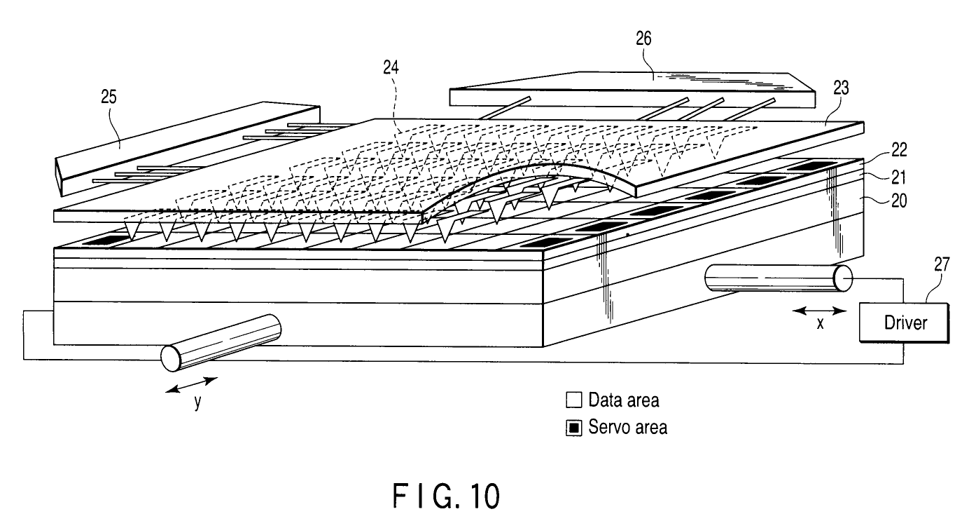

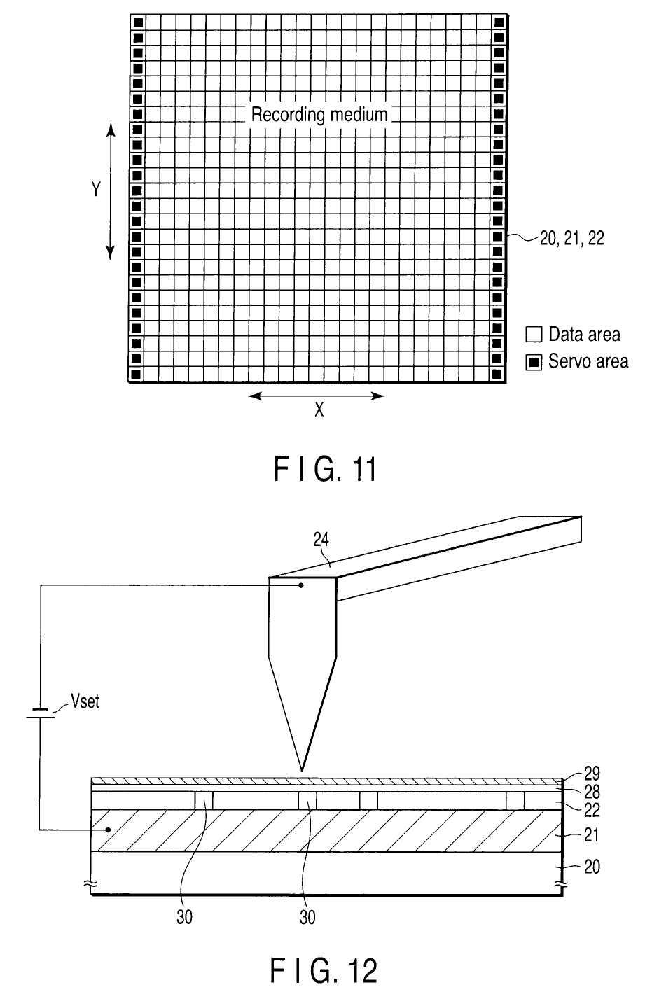

FIGS. 10 and 11 illustrate a probe type solid-state memory according to an example of the invention.

An electrode layer 21 is disposed on a semiconductor substrate 20, and a recording layer 22 comprising a data area and a servo area is disposed on the electrode layer 21. For example, the recording layer 22 is formed of a recording medium (recording portion) having the structure of FIG. 3. The recording medium is directly formed in a central portion of the semiconductor substrate 20.

The servo area is disposed along an edge of the semiconductor substrate 20.

The data area and the servo area are formed by plural blocks. Plural probes 24 are disposed on the data area and the servo area according to the plural blocks. Each of the plural probes 24 has a pointed top.

The plural probes 24 constitute a probe array and are formed in one of surfaces of the semiconductor substrate 23. The plural probes 24 can easily be formed in one of surfaces of the semiconductor substrate 23 by utilizing a MEMS technique.

A position of the probe 24 on the data area is controlled by a servo burst signal read from the servo area. Specifically, a driver 27 reciprocates the semiconductor substrate 20 in an X-direction to control the positions of the plural probes 24 in a Y-direction, thereby performing an access operation.

Alternatively, the recording medium may be independently formed in each block, the recording medium may have a circular rotating structure like a hard disk, and each of the plural probes 24 may move in a radial direction of the recording medium, for example, in the X-direction.

Each of the plural probes 24 acts as a recording/erasing head and a reproducing head. Multiplex drivers 25 and 26 supply predetermined voltages to the plural probes 24 during the recording, reproduction, and erasing.

B. Recording/Reproducing Operation

The recording/reproducing operation of the probe type solid-state memory of FIGS. 10 and 11 will be described.

FIG. 12 illustrates the recording operation (setting operation).

The recording medium comprises the electrode layer 21, the recording layer 22, a heater layer (resistive layer) 28, and a protective layer 29, which are formed on the semiconductor chip 20. The heater layer 28 is formed of a resistor according to the invention.

The leading end of the probe 24 comes into contact with a surface of the protective layer 29, and a voltage pulse is applied to a recording unit 30 of the recording layer (recording medium) 22 to generate the potential gradient in the recording unit 30 of the recording layer 22, thereby performing the information recording. In the example, the potential at the probe 24 is set relatively lower than the potential at the electrode layer 21. When the electrode layer 21 is set to the fixed potential (for example, ground potential), a negative potential may be provided to the probe 24.

For example, an electron generation source or a hot electron source is used for the voltage pulse, and the voltage pulse may be generated by emitting electrons from the probe 24 toward the electrode layer 21.

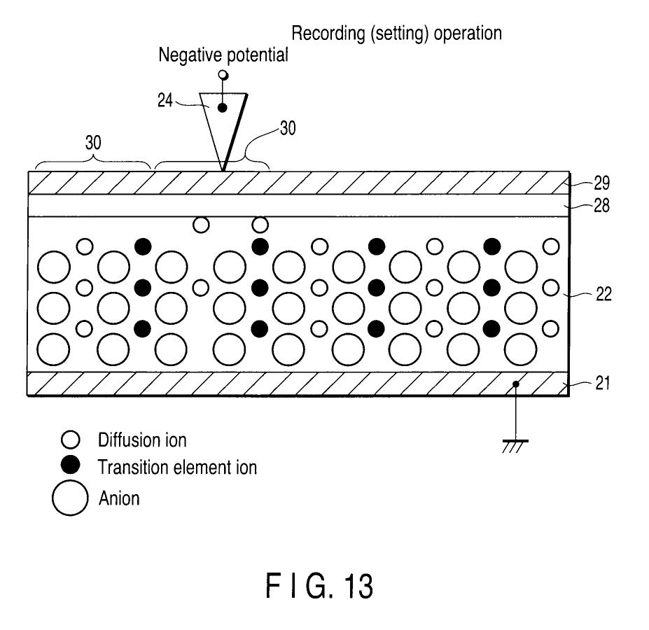

At this time, for example, as illustrated in FIG. 13, in the recording unit 30 of the recording layer 22, some diffusion ions move onto the side of the probe (cathode) 24, and the number of diffusion ions in the crystal decreases relative to the number of anions. The diffusion ions having moved onto the side of the probe 24 receive electrons from the probe 24 to be deposited as the metal.

The anions become excessive in the recording unit 30 of the recording layer 22 to increase the valence of transition element ion remaining in the recording layer 22. That is, because the recording unit 30 of the recording layer 22 has the electron conductivity due to the carrier injection by the phase change, the information recording (setting operation) is completed.

The voltage pulse necessary for the information recording may be generated by setting the potential at the probe 24 to a state relatively higher than the potential at the electrode layer 21.

According to the probe type solid-state memory of the example, like the hard disk, the information recording can be performed to the recording unit 30 of the recording medium, and the recording density higher than that of the conventional hard disk or semiconductor memory can be realized by the use of the novel recording material.

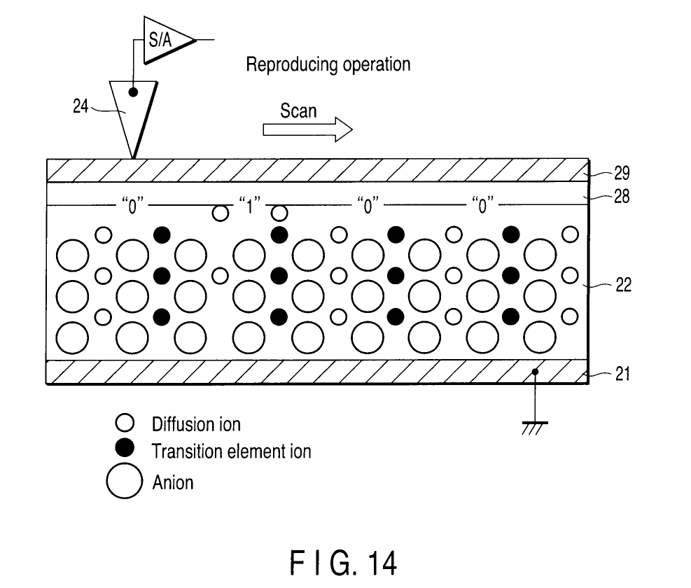

FIG. 14 illustrates the reproducing operation.

The voltage pulse is supplied to the recording unit 30 of the recording layer 22 to detect the resistance value of the recording unit 30 of the recording layer 22, thereby performing the reproducing operation. However, the voltage pulse is set to a minute value to an extent that the material of the recording unit 30 of the recording layer 22 does not cause the phase change.

For example, the read current generated by the sense amplifier S/A is passed from the probe 24 through the recording unit 30 of the recording layer (recording medium) 22, and the resistance value of the recording unit 30 is measured with the sense amplifier S/A. A resistance ratio of the high-resistance state and the low-resistance state of 10³ or more can be secured when the already-described new material is used.

In the reproducing operation, the probe 24 scans the recording medium to enable the continuous reproduction.

The recording unit 30 of the recording layer 22 is subjected to the Joule heating by the large current pulse to promote the redox reaction in the recording unit 30 of the recording layer 22, thereby performing the erasing (resetting) operation. Alternatively, the voltage pulse in the opposite direction to the setting operation can be applied to the recording layer 22 to perform the erasing operation.

The erasing operation can be performed in each recording unit 30 or in the plural recording units 30 or the block unit.

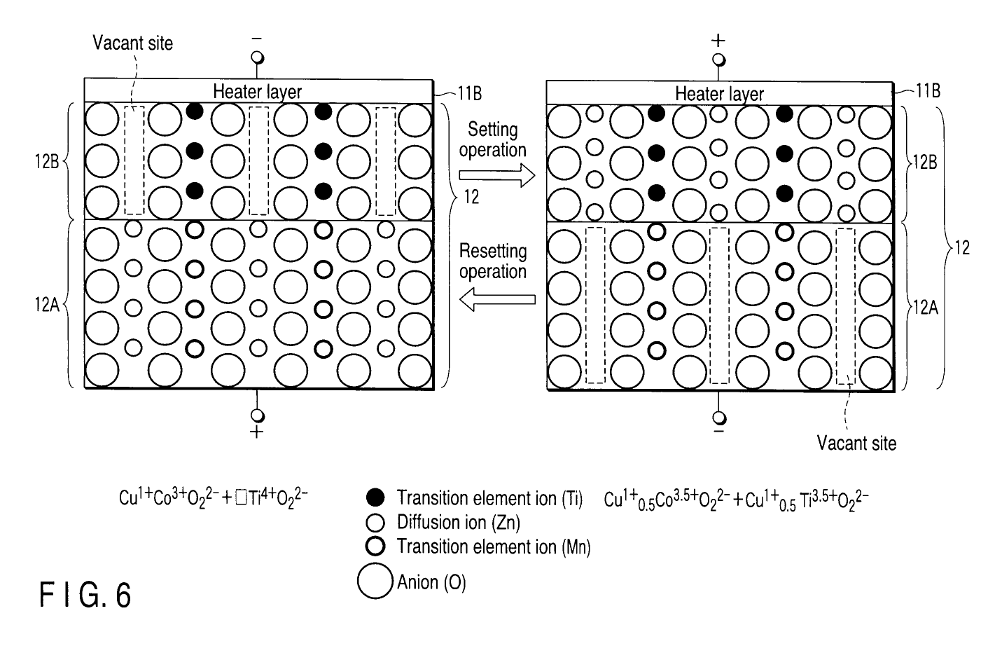

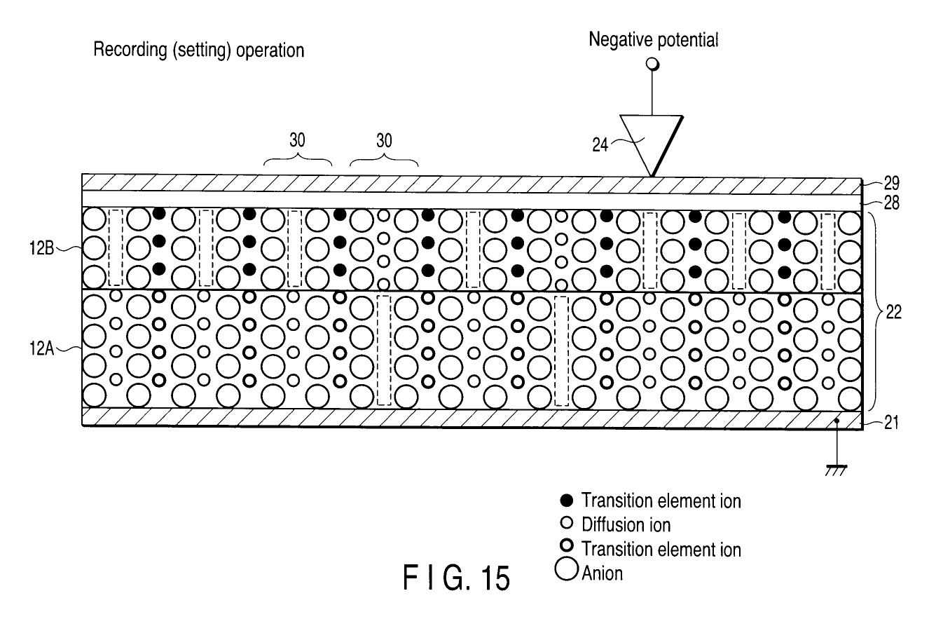

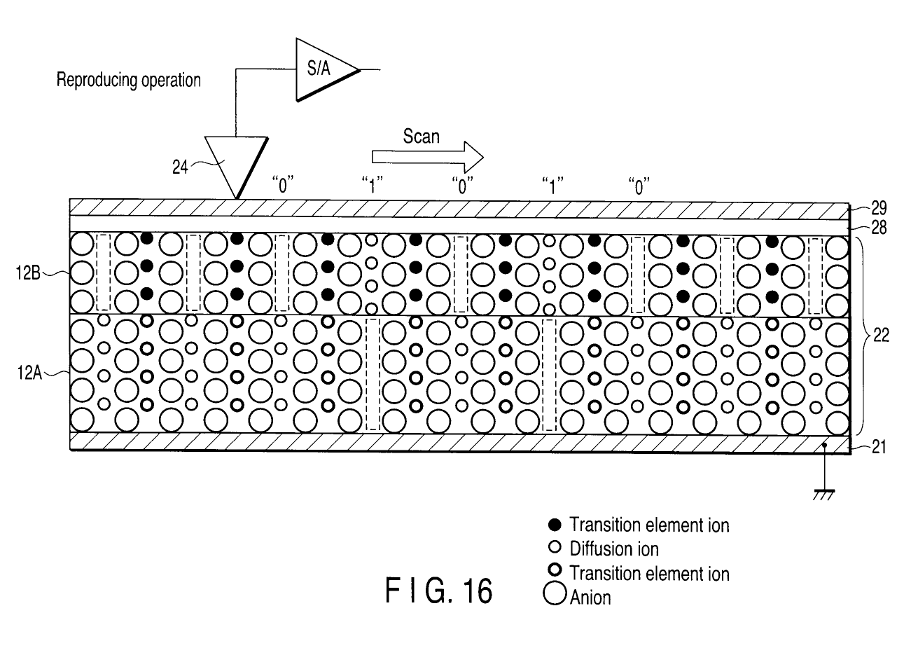

FIG. 15 illustrates the recording operation performed to the structure of FIG. 6, and FIG. 16 illustrates the reproducing operation performed to the structure of FIG. 6.

C. Conclusion

According to the probe type solid-state memory, the high recording density and the low power consumption can be realized compared with the current hard disk and flash memory.

(2) Cross-Point Type Solid-State Memory

A. Structure

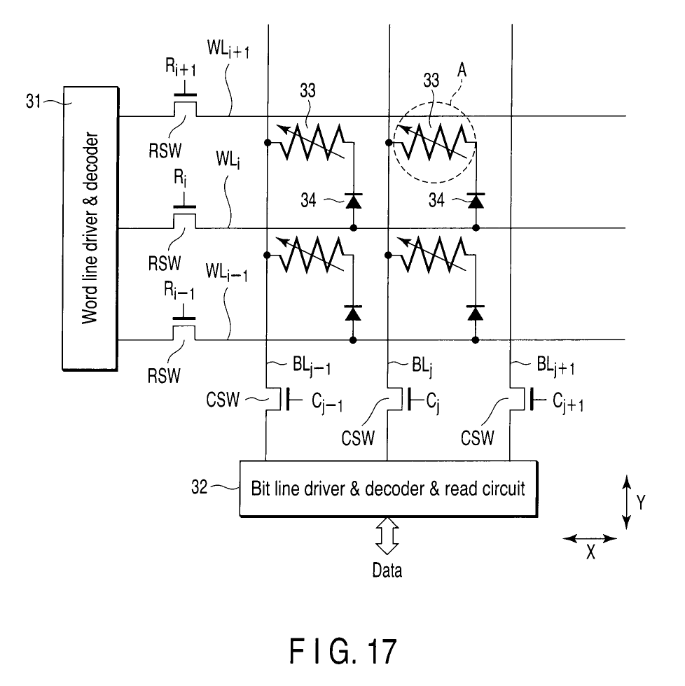

FIG. 17 illustrates the cross-point type solid-state memory according to an example of the invention.

Word lines WLᵢ₋₁, WLᵢ, and WLᵢ₊₁ extend in the X-direction, and bit lines BLⱼ₋₁, BLⱼ, and BLⱼ₊₁ extend in the Y-direction.

One end of each of the word lines WLᵢ₋₁, WLᵢ, and WLᵢ₊₁ is connected to a word line driver and decoder 31 through a MOS transistor RSW that is a selection switch. One end of each of the bit lines BLᵢ₋₁, BLᵢ, and BLᵢ₊₁ is connected to a bit line driver and decoder and read circuit 32 through a MOS transistor CSW that is a selection switch.

Selection signals Rᵢ₋₁, Rᵢ, and Rᵢ₊₁ are input to gates of the MOS transistors RSW to select one word line (row), and selection signals Cᵢ₋₁, Cᵢ, and Cᵢ₊₁ are input to gates of the MOS transistors CSW to select one bit line (column).

A memory cell 33 is disposed in an intersection portion of each of the word lines WLᵢ₋₁, WLᵢ, and WLᵢ₊₁ and each of the bit lines BLⱼ₋₁, BLⱼ, and BLⱼ₊₁. This is a so-called cross-point type cell array structure.

A diode 34 is added to the memory cell 33 in order to prevent sneak current during the recording/reproduction.

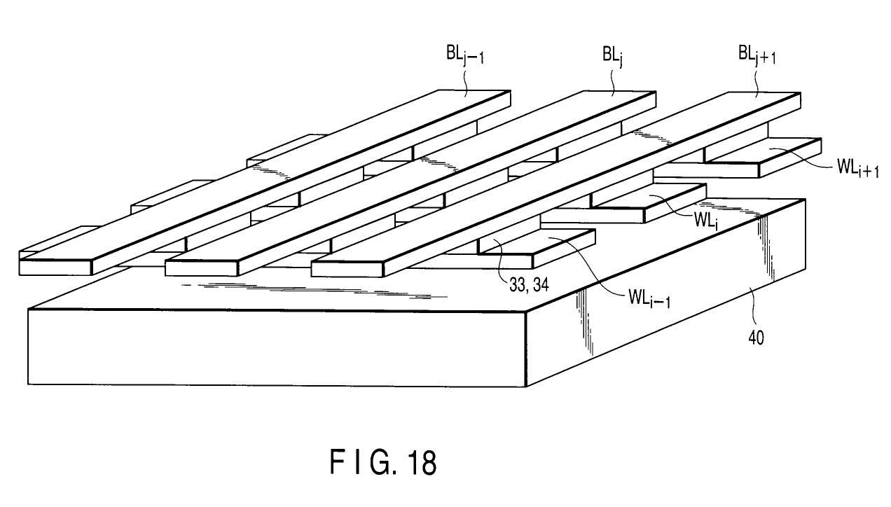

FIG. 18 illustrates a structure of a memory cell array portion of the cross-point type solid-state memory of FIG. 17.

The word lines WLᵢ₋₁, WLᵢ, and WLᵢ₊₁ and the bit lines BLⱼ₋₁, BLⱼ, and BLⱼ₊₁ are disposed on a semiconductor chip 40, and the memory cell 33 and the diode 34 are disposed in the intersection portion of the interconnections.

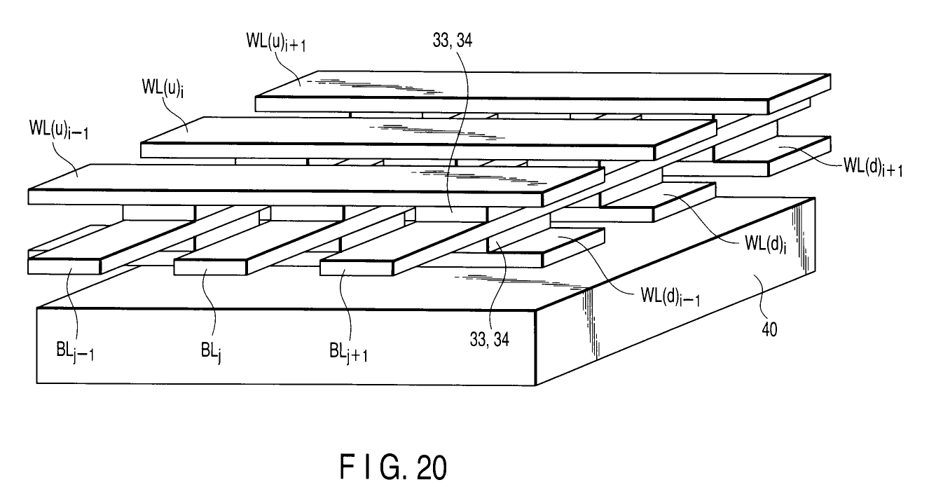

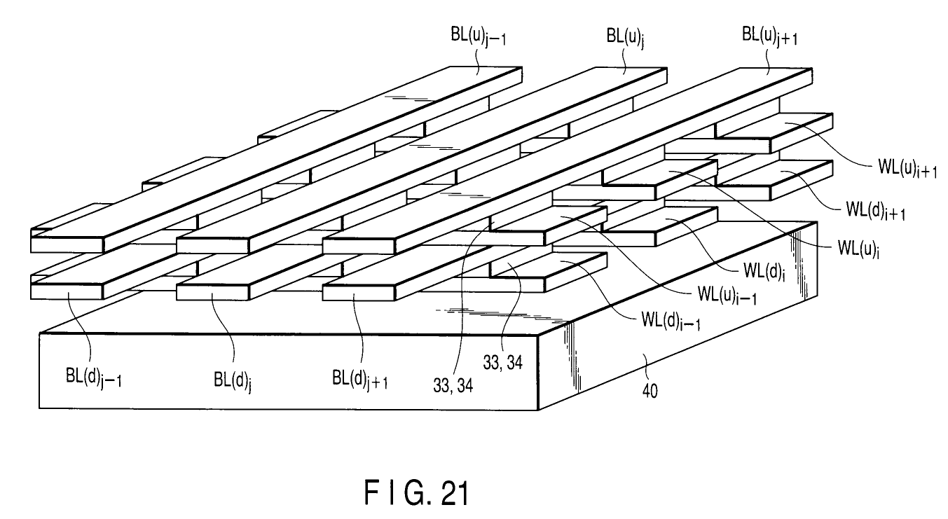

The distinctive feature of the cross-point type cell array structure is that high integration is advantageously achieved because the necessity to individually connect the MOS transistor to the memory cell 33 is eliminated. For example, as illustrated in FIGS. 20 and 21, the memory cells 33 can be stacked to form a three-dimensional structure of the memory cell array.

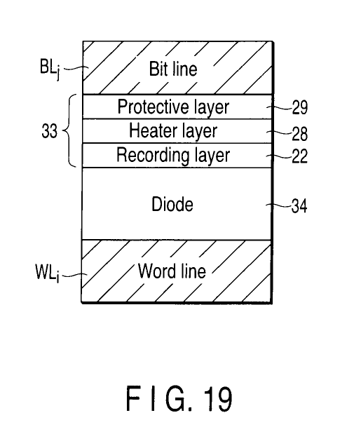

For example, as illustrated in FIG. 19, the memory cell 33 has a stacked structure comprising the recording layer 22, the heater layer (resistive layer) 28, and the protective layer 29. One-bit data is stored in one memory cell 33. The diode 34 is disposed between the word line WLᵢ and the memory cell 33.

B. Recording/Reproducing Operation

The recording/reproducing operation will be described with reference to FIGS. 17 to 19.

In this case, it is assumed that the memory cell 33 surrounded by a dotted line A is selected to perform the recording/reproducing operation to the selected memory cell 33.

In the information recording (setting operation), the voltage is applied to the selected memory cell 33, and the potential gradient is generated in the memory cell 33 to pass the current pulse through the memory cell 33. Therefore, for example, the potential at the word line WLᵢ is set relatively lower than the potential at the bit line BLᵢ. A negative potential is provided to the word line WLᵢ when the bit line BLᵢ is set to the fixed potential (for example, ground potential).

At this time, in the selected memory cell 33 surrounded by the dotted line A, some diffusion ions move onto the side of the word line (cathode) WLᵢ, and the number of diffusion ions in the crystal decreases relative to the number of anions. The diffusion ions having moved onto the side of the word line WLᵢ receive electrons from the word line WLᵢ to be deposited as the metal.

In the selected memory cell 33 surrounded by the dotted line A, the anions become excessive to increase the valence of transition element ion remaining in the crystal. That is, because the selected memory cell 33 surrounded by the dotted line A has the electron conductivity due to the carrier injection by the phase change, the information recording (setting operation) is completed.

Preferably all the unselected word lines WLᵢ₋₁ and WLᵢ₊₁ and all the unselected bit lines BLⱼ₋₁ and BLⱼ₊₁ are biased to the same potential during the information recording.

Preferably all the word lines WLᵢ₋₁, WLᵢ, and WLᵢ₊₁ and all the bit lines BLⱼ₋₁, BLⱼ, and BLⱼ₊₁ are pre-charged during standby before the information recording.

The voltage pulse necessary for the information recording may be generated by setting the potential at the word line WLᵢ to the state relatively higher than the potential at the bit line BLⱼ.

The pulse current is passed through the selected memory cell 33 surrounded by the dotted line A, and the resistance value of the memory cell 33 is detected to perform the information reproduction. However, it is necessary that the pulse current be set to a minute value to an extent that the material of the memory cell 33 does not cause the phase change.

For example, the read current (pulse current) generated by the read circuit is passed from the bit line BLⱼ through the memory cell 33 surrounded by the dotted line A, and the resistance value of the memory cell 33 is measured by the read circuit. A resistance ratio of the high-resistance state and the low-resistance state of 10³ or more can be secured when the already-described new material is used.

The selected memory cell 33 surrounded by the dotted line A is subjected to the Joule heating by the large current pulse, and the redox reaction is promoted in the memory cell 33 to perform the erasing (reset) operation.

C. Conclusion

According to the cross-point type solid-state memory, the high recording density and the low power consumption can be realized compared with the current hard disk and flash memory.

(3) Other

Although the probe type solid-state memory and the cross-point type solid-state memory have been described in the embodiment, the material and principle that are proposed in the example of the invention can also be applied to the current recording medium such as the hard disk and the DVD.

### 4. Application to Flash Memory

(1) Structure

The example of the invention can also be applied to the flash memory.

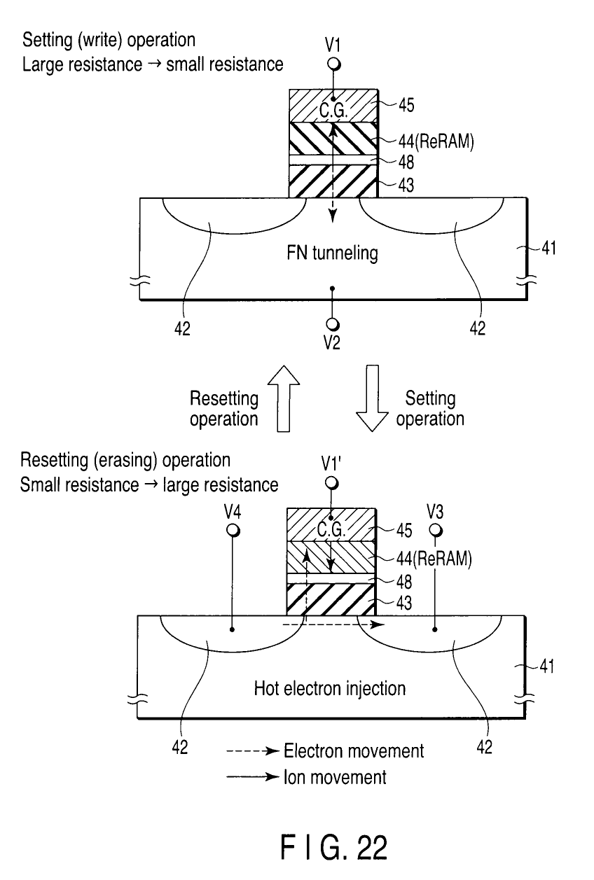

FIG. 22 illustrates a memory cell of the flash memory.

The memory cell of the flash memory comprises an MIS (Metal-Insulator-Semiconductor) transistor.

A diffusion layer 42 is formed in a surface region of a semiconductor substrate 41. A gate insulating layer 43 is formed on a channel region between the diffusion layers 42. A heater layer (resistive layer) 48 according to the invention is formed on the gate insulating layer 43, and a recording layer (ReRAM: Resistive RAM) 44 is formed on the heater layer 48. A control gate electrode 45 is formed on the recording layer 44.

The semiconductor substrate 41 may be a well region, and the semiconductor substrate 41 and the diffusion layer 42 have conductivity types opposite to each other. The control gate electrode 45 constitutes the word line and is made of, for example, conductive polysilicon.

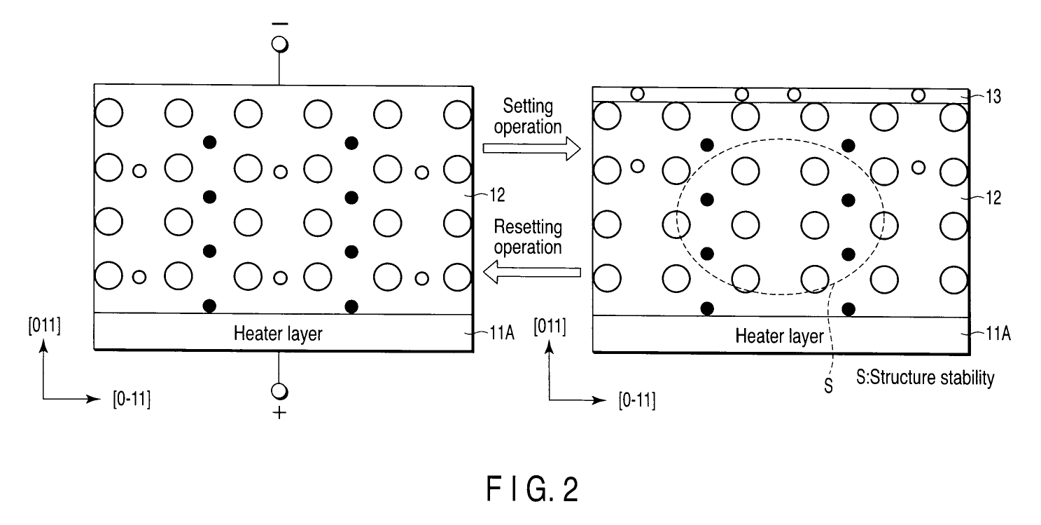

The recording layer 44 and the heater layer 48 are made of one of the materials illustrated in FIGS. 1 to 9.

(2) Basic Operation

A basic operation will be described with reference to FIG. 22.

A potential V1 is provided to the control gate electrode 45, and a potential V2 is provided to the semiconductor substrate 41, thereby performing the setting (write) operation.

It is necessary that a difference between the potentials V1 and V2 have magnitude enough to cause the phase change or resistance change in the recording layer 44. However, there is no particular limitation to the orientation of the difference.

That is, either V1>V2 or V1<V2 is permitted.

For example, assuming that the recording layer 44 is the insulator (large resistance) in the initial state (reset state), a threshold of the memory cell (MIS transistor) is raised because the gate insulating layer 43 is substantially thickened.

When the potentials V1 and V2 are provided to change the recording layer 44 to the conductor (small resistance), the threshold of the memory cell (MIS transistor) is lowered because the gate insulating layer 43 is substantially thinned.

Although the potential V2 is provided to the semiconductor substrate 41, the potential V2 may be instead transferred from the diffusion layer 42 to the channel region of the memory cell.

A potential V1′ is provided to the control gate electrode 45, a potential V3 is provided to one of the diffusion layers 42, and a potential V4 (<V3) is provided to the other diffusion layer 42, thereby performing the reset (erasing) operation.

The potential V1′ is set to a value that exceeds the threshold of the memory cell in the set state.

At this time, the memory cell is turned on, electrons flow from the other diffusion layer 42 toward one of the diffusion layers 42, and the hot electrons are generated. A temperature of the recording layer 44 is raised because the hot electrons are injected into the recording layer 44 through the gate insulating layer 43.

The temperature rise is accelerated by the Joule heat from the heater layer 48.

Therefore, because the recording layer 44 changes the conductor (small resistance) to the insulator (large resistance), the gate insulating layer 43 is substantially thickened to raise the threshold of the memory cell (MIS transistor).

The threshold of the memory cell is changed by the principle similar to that of the flash memory, so that the information recording and reproducing device according to the example of the invention can be implemented by utilizing the flash memory technology.

(3) NAND Type Flash Memory

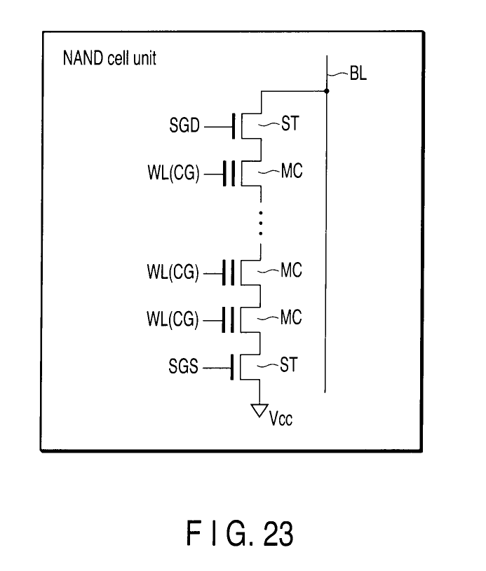

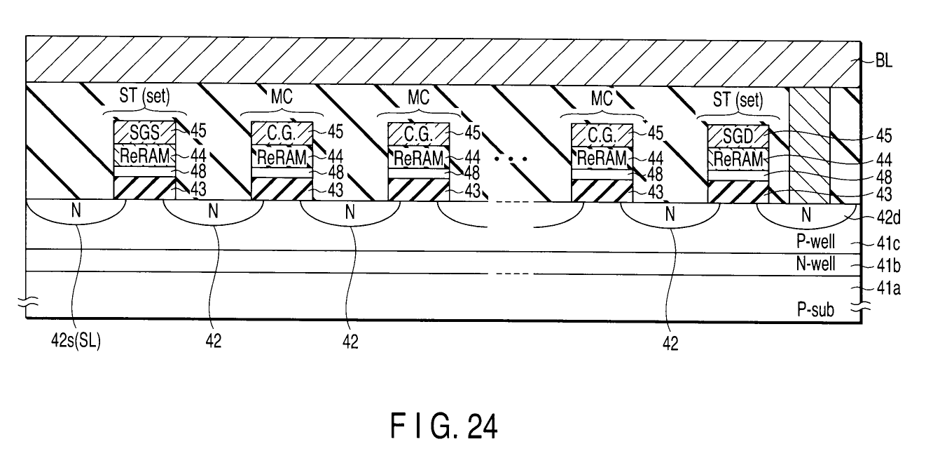

FIG. 23 illustrates a circuit diagram of a NAND cell unit. FIG. 24 illustrates a structure of a NAND cell unit according to an example of the invention.

An N-type well region 41b and a P-type well region 41c are formed in a P-type semiconductor substrate 41a. A NAND cell unit according to an example of the invention is formed in the P-type well region 41c.

The NAND cell unit comprises a NAND string in which plural memory cells MC are connected in series and two select gate transistors ST each of which is connected to each end of the NAND string.

The memory cell MC and the select gate transistor ST have the same structure. Specifically, each of the memory cell MC and the select gate transistor ST comprises the N-type diffusion layer 42, the gate insulating layer 43 formed on the channel region between the N-type diffusion layers 42, the heater layer (resistive layer) 48 formed on the gate insulating layer 43, the recording layer (ReRAM) 44 formed on the heater layer 48, and the control gate electrode 45 formed on the recording layer 44.

The state (insulator/conductor) of the recording layer 44 of the memory cell MC can be changed by the basic operation. On the other hand, the recording layer 44 of the select gate transistor ST is fixed to the set state, that is, the conductor (small resistance).

One of the select gate transistors ST is connected to the source line SL, and the other is connected to the bit line BL.

It is assumed that all the memory cells in the NAND cell unit are in the reset state (large resistance) before the setting (write) operation.

The setting (write) operation is performed one by one from the memory cell MC on the side of the source line SL toward the memory cell MC on the side of the bit line BL.

A write potential V1 (positive potential) is provided to the selected word line (control gate electrode) WL, and a transfer potential (potential at which the memory cell MC is turned on) Vpass is provided to the unselected word line WL.

The select gate transistor ST on the side of the source line SL is turned off, the select gate transistor ST on the side of the bit line BL is turned on, and the program data is transferred from the bit line BL to the channel region of the selected memory cell MC.

For example, when the program data is “1”, a write inhibit potential (for example, a potential similar to the potential V1) is transferred to the channel region of the selected memory cell MC such that the resistance value of the recording layer 44 of the selected memory cell MC does not change from the high resistance state to the low resistance state.

When the program data is “0”, the potential V2 (<V1) is transferred to the channel region of the selected memory cell MC, and the resistance value of the recording layer 44 of the selected memory cell MC is changed from the high resistance state to the low resistance state.

In the reset (erasing) operation, for example, the potential V1′ is provided to all the word lines (control gate electrode) WL to turn on all the memory cells MC in the NAND cell unit. The two select gate transistors ST are turned on, the potential V3 is provided to the bit line BL, and the potential V4 (<V3) is provided to the source line SL.

At this time, because hot electrons are injected into the recording layers 44 of all the memory cells MC in the NAND cell unit, the resetting operation is collectively performed to all the memory cells MC in the NAND cell unit.

The heater layer 48 serves as a heat source during the setting/resetting operation.

In the read operation, the read potential (positive potential) is provided to the selected word line (control gate electrode) WL, and a potential is provided to the unselected word line (control gate electrode) WL such that the memory cell MC is turned on irrespective of data “0” and “1”.

The two select gate transistors ST are turned on to supply the read current to the NAND string.

When the read potential is applied to the selected memory cell MC, because the selected memory cell MC is turned on or off according to the data value stored therein, the data can be read by detecting, for example, the change in read current.

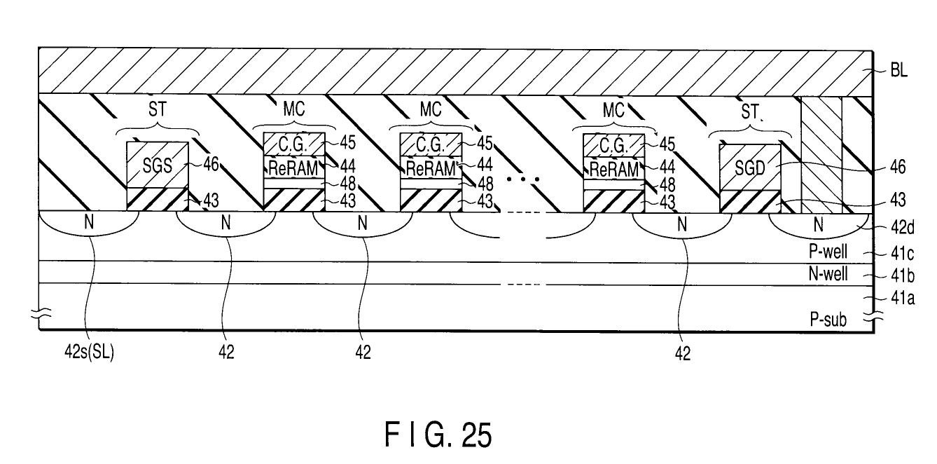

In the structure of FIG. 24, the select gate transistor ST has the same structure as the memory cell MC. For example, as illustrated in FIG. 25, the recording layer is not formed in the select gate transistor ST, but the select gate transistor ST is formed by the usual MIS transistor.

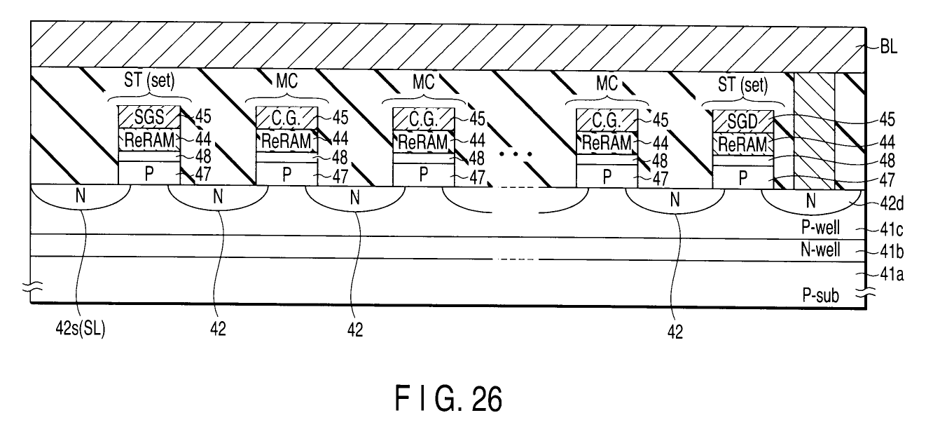

FIG. 26 is a modification example of the NAND type flash memory.

The distinctive feature of the modification is that the gate insulating layers of the plural memory cells MC constituting the NAND string are replaced by P-type semiconductor layers 47.

When the memory cell MC is more finely produced with the progress of high integration, the P-type semiconductor layer 47 is filled with a depletion layer in the state in which the voltage is not provided.

During the setting (write), the positive write potential (for example, 3.5 V) is provided to the control gate electrode 45 of the selected memory cell MC, and the positive transfer potential (for example, 1 V) is provided to the control gate electrode 45 of the unselected memory cell MC.

At this time, the surfaces of the P-type well regions 41c of the plural memory cells MC in the NAND string are inverted from the P-type to the N-type to form the channel.

Therefore, as described above, the select gate transistor ST on the side of the bit line BL is turned on, and the program data “0” is transferred from the bit line BL to the channel region of the selected memory cell MC, which allows the setting operation to be performed.

The negative erasing potential (for example, −3.5 V) is provided to all the control gate electrodes 45, and the ground potential (0 V) is provided to the P-type well region 41c and the P-type semiconductor layer 47, which allows the resetting (erasing) to be collectively performed to all the memory cells MC constituting the NAND string.

During the read, the positive read potential (for example, 0.5 V) is provided to the control gate electrode 45 of the selected memory cell MC, and the transfer potential (for example, 1 V) is provided to the control gate electrode 45 of the unselected memory cell MC such that the memory cell MC is turned on irrespective of the data “0” and “1”.

It is assumed that a threshold voltage Vth“1” of the memory cell MC in the “1” state is in a range of 0 V<Vth“1”<0.5 V, and that a threshold voltage Vth“0” of the memory cell MC in the “0” state is in a range of 0.5 V<Vth“0”<1 V.

The two select gate transistors ST are turned on to supply the read current to the NAND string.

Therefore, an amount of current passed through the NAND string changes according to the data value stored in the selected memory cell MC, so that the data can be read by detecting the change of the current.

In the modification, preferably a hole-doped amount of the P-type semiconductor layer 47 is larger than that of the P-type well region 41c, and preferably a Fermi level of the P-type semiconductor layer 47 is deeper than that of the P-type well region 41c by about 0.5 V.

This is because the inversion from the P-type to the N-type is started from the surface portion of the P-type well region 41c between the N-type diffusion layers 42 to form the channel when the positive potential is provided to the control gate electrode 45.

Therefore, for example, the channel of the unselected memory cell MC is formed only at the interface between the P-type well region 41c and the P-type semiconductor layer 47 during the write, and the channels of the plural memory cells MC in the NAND string are formed only at the interfaces between the P-type well regions 41c and the P-type semiconductor layers 47 during the read.

That is, even if the recording layer 44 of the memory cell MC is the conductor (set state), the diffusion layer 42 and the control gate electrode 45 are not short-circuited.

(4) NOR Type Flash Memory

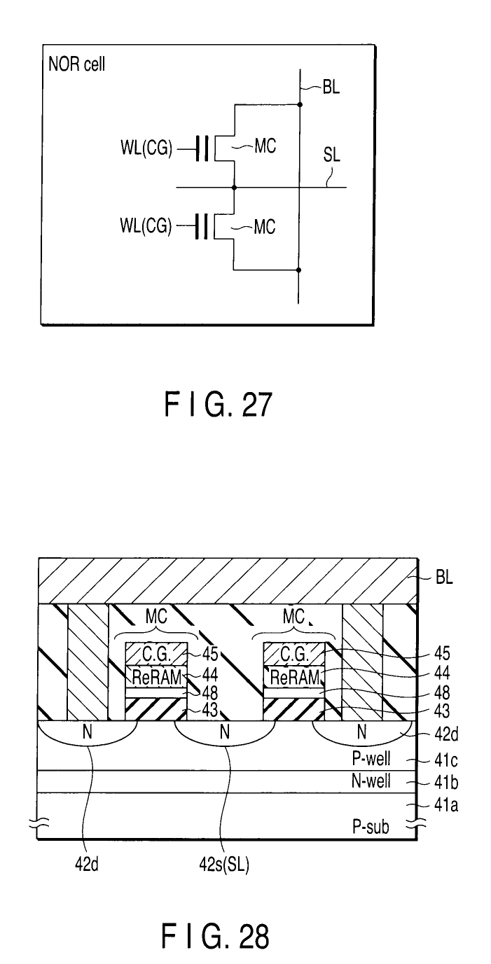

FIG. 27 illustrates a circuit diagram of a NOR cell unit. FIG. 28 illustrates a structure of a NOR cell unit according to an example of the invention.

The N-type well region 41b and the P-type well region 41c are formed in the P-type semiconductor substrate 41a. A NOR cell according to an example of the invention is formed in the P-type well region 41c.

The NOR cell comprises one memory cell (MIS transistor) MC connected between the bit line BL and the source line SL.

The memory cell MC comprises the N-type diffusion layer 42, the gate insulating layer 43 formed on the channel region between the N-type diffusion layers 42, the heater layer (resistive layer) 48 formed on the gate insulating layer 43, the recording layer (ReRAM) 44 formed on the heater layer 48, and the control gate electrode 45 formed on the recording layer 44.

The state (insulator/conductor) of the recording layer 44 of the memory cell MC can be changed by the basic operation.

(5) Two-Transistor Type Flash Memory

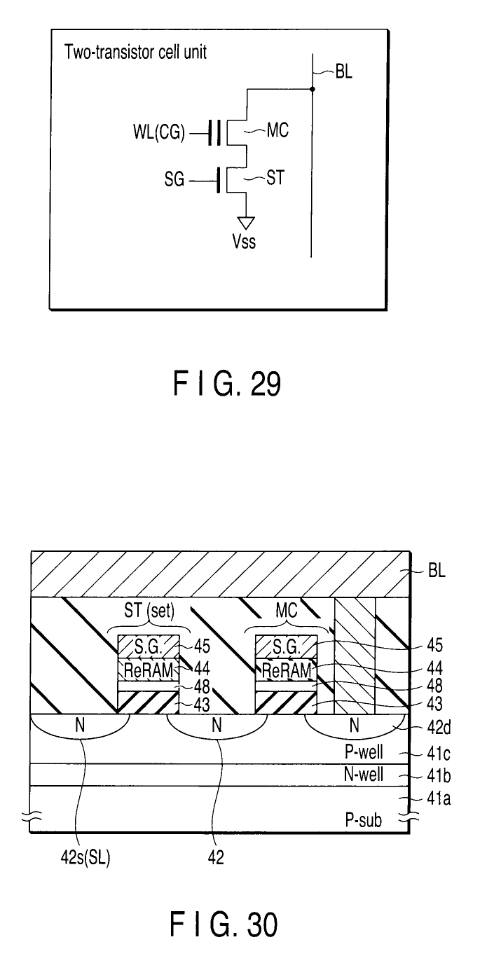

FIG. 29 illustrates a circuit diagram of a two-transistor cell unit. FIG. 30 illustrates a structure of a two-transistor cell unit according to an example of the invention.

Recently the two-transistor cell unit has been developed as the new cell structure having both the feature of the NAND cell unit and the feature of the NOR cell.

The N-type well region 41b and the P-type well region 41c are formed in the P-type semiconductor substrate 41a. The two-transistor cell unit according to the example of the invention is formed in the P-type well region 41c.

The two-transistor cell unit comprises one memory cell MC and one select gate transistor ST, which are connected in series.

The memory cell MC and the select gate transistor ST have the same structure. Specifically, each of the memory cell MC and the select gate transistor ST comprises the N-type diffusion layer 42, the gate insulating layer 43 formed on the channel region between the N-type diffusion layers 42, the heater layer (resistive layer) 48 formed on the gate insulating layer 43, the recording layer (ReRAM) 44 formed on the heater layer 48, and the control gate electrode 45 formed on the recording layer 44.

The state (insulator/conductor) of the recording layer 44 of the memory cell MC can be changed by the basic operation. On the other hand, the recording layer 44 of the select gate transistor ST is fixed to the set state, that is, the conductor (small resistance).

The select gate transistor ST is connected to the source line SL, and the memory cell MC is connected to the bit line BL.

The state (insulator/conductor) of the recording layer 44 of the memory cell MC can be changed by the basic operation.

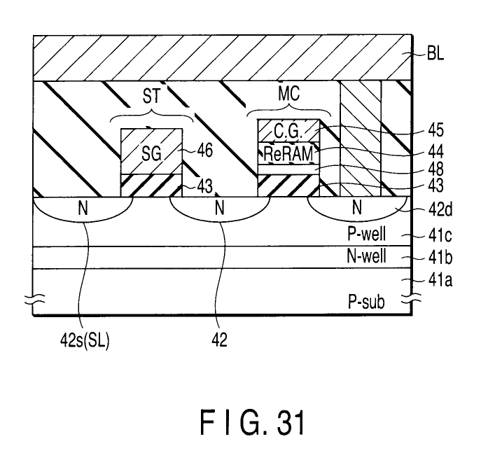

In the structure of FIG. 30, the select gate transistor ST has the same structure as the memory cell MC. However, for example, as illustrated in FIG. 31, the recording layer may not be formed in the select gate transistor ST, but the select gate transistor ST may be formed by the usual MIS transistor.

### 5. Experimental Examples

Experimental examples in which some samples were produced to evaluate a resistance difference between the initial (erasing) state and the recording (write) state will be described.

A simplified sample in which the recording portion according to an example of the invention is formed on a disk made of a glass substrate having a diameter of about 60 mm and a thickness of about 1 mm is used.

### (1) First Experimental Example

A sample of a first experimental example is produced as follows.

The recording portion has a stacked structure comprising an underlayer, an electrode layer, a recording layer, a heater layer (resistive layer), and a protective layer. After the CeO₂ underlayer having the thickness of about 50 nm is stacked on the disk, a TiN film having the thickness of 100 nm is stacked to form the electrode layer. Then an AlN film is further stacked thereon to form the heater layer (resistive layer).

The recording layer is made of ZnNiTiO₄ having a spinel structure, and the protective layer is made of diamond-like carbon (DLC).

For example, a temperature of a disk is maintained within a range of 600° C. to 900° C., and RF magnetron sputtering is performed in atmosphere of 95.5% Ar and 0.5% O₂, thereby forming ZnNiTiO₄ on the disk with the thickness of about 10 nm. For example, the diamond-like carbon is formed on ZnNiTiO₄ with the thickness of about 3 nm by a CVD method.

The samples are evaluated with a tungsten (W) probe whose pointed top has a diameter of 10 nm or less.

The pointed top of the probe is brought into contact with the surface of the recording portion, the 1-V voltage pulse having a width of 10 nsec is applied between the electrode layer and the probe during the write, and the 0.2-V voltage pulse having the width of 100 nsec is applied between the electrode layer and the probe during the erasing.

After the write/erase, the 0.1-V voltage pulse having the width of 10 nsec is applied between the electrode layer and the probe to measure the resistance value of the recording layer. The resistance value was changed to 2×10⁴Ω in the recording (write) state, while being a level of 10⁷Ω in the initial (erasing) state.

### (2) Second Experimental Example

In a second experimental example, the same sample as the first experimental example is used except that the heater layer (resistive layer) is made of Si₃N₄. The producing method and the evaluation method are similar to those of the first experimental example.

The resistance value was changed to 2×10⁴Ω in the recording (write) state, while being a level of 10⁷Ω in the initial (erasing) state.

### (3) Third Experimental Example

In a third experimental example, the same sample as the first experimental example is used except that the heater layer (resistive layer) is made of LaN. The producing method and the evaluation method are similar to those of the first experimental example.

The resistance value was changed to 2×10⁴Ω in the recording (write) state, while being a level of 10⁷Ω in the initial (erasing) state.

### (4) Fourth Experimental Example

In a fourth experimental example, the same sample as the first experimental example is used except that the electrode layer is made of TaN and the heater layer (resistive layer) is made of TaON. The producing method and the evaluation method are similar to those of the first experimental example.

The resistance value was changed to 1×10⁴Ω in the recording (write) state, while being a level of 10⁷Ω in the initial (erasing) state.

### (5) Fifth Experimental Example

In a fifth experimental example, the same sample as the first experimental example is used except that the resistive layer is made of B₄C. The producing method and the evaluation method are similar to those of the first experimental example.

The resistance value was changed to 3×10⁴Ω in the recording (write) state, while being a level of 10⁷Ω in the initial (erasing) state.

### (6) Sixth Experimental Example

In a sixth experimental example, the same sample as the first experimental example is used except that the electrode layer is made of LaNiO₃ and the heater layer (resistive layer) is made of LaN. The producing method and the evaluation method are similar to those of the first experimental example.

The resistance value was changed to 2×10⁴Ω in the recording (write) state, while being a level of 10⁷Ω in the initial (erasing) state.

### (7) Seventh Experimental Example

In a seventh experimental example, the same sample as the first experimental example is used except that the heater layer (resistive layer) is made of amorphous carbon to which a trace amount of F element is added. The producing method and the evaluation method are similar to those of the first experimental example.

The resistance value was changed to 1×10⁴Ω in the recording (write) state, while being a level of 10⁷Ω in the initial (erasing) state.

### (8) Eighth Experimental Example

In an eighth experimental example, the same sample as the first experimental example is used except that the heater layer (resistive layer) is made of DLC (Diamond-Like Carbon). The producing method and the evaluation method are similar to those of the first experimental example.

The resistance value was changed to 4×10⁴Ω in the recording (write) state, while being a level of 10⁷Ω in the initial (erasing) state.

### (9) Ninth Experimental Example

In a ninth experimental example, the same sample as the first experimental example is used except that the heater layer (resistive layer) is made of amorphous boron. The producing method and the evaluation method are similar to those of the first experimental example.

The resistance value was changed to 2×10⁴Ω in the recording (write) state, while being a level of 10⁷Ω in the initial (erasing) state.

### (10) Tenth Experimental Example

In a tenth experimental example, the same sample as the first experimental example is used except that the heater layer (resistive layer) is made of BN. The producing method and the evaluation method are similar to those of the first experimental example.

The resistance value was changed to 5×10⁴Ω in the recording (write) state, while being a level of 10⁷Ω in the initial (erasing) state.

(11) Eleventh Experimental Example

In an eleventh experimental example, after a CeO₂ buffer layer (underlayer) is formed with the thickness of about 50 nm, a W interconnection layer is formed with the thickness of about 100 nm. The word line is formed on the interconnection layer, and a vertical diode is formed on the word line.

The electrode layer made of TiN is formed with the thickness of about 10 nm on the vertical diode, the heater layer (resistive layer) made of AlN is formed with the thickness of about 5 nm on the electrode layer, the recording layer made of ZnNiTiO₄ is stacked with the thickness of about 10 nm on the heater layer, and the second compound made of TiO₂ having the vacant site is formed with the thickness of about 10 nm on the recording layer. After the electrode layer made of TiN is formed again with the thickness of about 100 nm on the second compound, the bit line is formed on the electrode layer.

The measurement was performed similarly to the first experimental example except that the potential was applied between the word line and the bit line. As to the orientation of the diode, the direction in which the electrons flow from the lower electrode toward the upper electrode is set to a forward direction.

In this case, the resistance value was changed to 2×10⁴Ω in the recording (write) state, while being a level of 10⁷Ω in the initial (erasing) state.

### (12) Twelfth Experimental Example

In a twelfth experimental example, the same sample as the eleventh experimental example is used except that the electrode layer is made of TaN and the heater layer (resistive layer) is made of TaON. The producing method and the evaluation method are similar to those of the first experimental example.

The resistance value was changed to 2×10⁴Ω in the recording (write) state, while being a level of 10⁷Ω in the initial (erasing) state.

### (13) First Comparative Example

In a first comparative example, the same sample as the eleventh experimental example is used except that the heater layer (resistive layer) is not used. The producing method and the evaluation method are similar to those of the first experimental example.

The resistance value was changed to 3×10⁴Ω in the recording (write) state, while being a level of 10⁷Ω in the initial (erasing) state.

### (14) Second Comparative Example

In a second comparative example, the same sample as the eleventh experimental example is used except that the heater layer (resistive layer) is located immediately below the upper electrode.

The producing method and the evaluation method are similar to those of the eleventh experimental example.

The resistance value was changed to 3×10³Ω in the recording (write) state, while being a level of 10⁴ to 10⁵Ω in the initial (erasing) state.

### (15) Third Comparative Example

In a third comparative example, the same sample as the twelfth experimental example is used except that the heater layer (resistive layer) is located immediately below the upper electrode.

The producing method and the evaluation method are similar to those of the twelfth experimental example.

The resistance value was changed to 3×10³Ω in the recording (write) state, while being a level of 10⁴ to 10⁵Ω in the initial (erasing) state.

### (16) Conclusion

As described above, in any one of the first to twelfth experimental examples, the resistance value is raised after the recording while the power consumption is reduced during the resetting compared with the first to third comparative examples to which the invention is not applied.

In the second and third comparative examples in which the position of the heater layer (resistive layer) is reversely disposed, the sufficiently high resistance state is not obtained after the erasing operation, resulting in the decrease in the on/off ratio. This is the result indicating the effectiveness of the invention.

Table 1 illustrates verification results of the first to twelfth experimental examples and the first to third comparative examples.

TABLE 1

| | | | | | Recording | Protective | | |
|---|---|---|---|---|---|---|---|---|
| | | | | | layer | layer | Resistance | Resistance |
| | | | Electrode | Resistive | (or first | (or second | value after | value before |
| | Mode | Underlayer | layer | layer | compound) | compound) | recording Ω | recording Ω |
| First | Probe | CeO₂ | TiN | AIN | ZnNiTiO₄ | DLC | 2.E+04 | 1.E+07 |
| experimental | memory | | | | | | | |
| example | | | | | | | | |
| Second | Probe | CeO₂ | TiN | Si₃N₄ | ZnNiTiO₄ | DLC | 2.E+04 | 1.E+07 |
| experimental | memory | | | | | | | |
| example | | | | | | | | |
| Third | Probe | CeO₂ | TiN | LaN | ZnNiTiO₄ | DLC | 2.E+04 | 1.E+07 |
| experimental | memory | | | | | | | |
| example | | | | | | | | |
| fourth | Probe | CeO₂ | TaN | TaON | ZnNiTiO₄ | DLC | 1.E+04 | 1.E+07 |
| experimental | memory | | | | | | | |
| example | | | | | | | | |
| Fifth | Probe | CeO₂ | TiN | B₄C | ZnNiTiO₄ | DLC | 3.E+04 | 1.E+07 |
| experimental | memory | | | | | | | |
| example | | | | | | | | |
| Sixth | Probe | CeO₂ | LaNiO₃ | LaN | ZnNiTiO₄ | DLC | 2.E+04 | 1.E+07 |
| experimental | memory | | | | | | | |
| example | | | | | | | | |
| Seventh | Probe | CeO₂ | TiN | amo-C + F | ZnNiTiO₄ | DLC | 1.E+04 | 1.E+07 |
| experimental | memory | | | | | | | |
| example | | | | | | | | |
| Eighth | Probe | CeO₂ | TiN | DLC | ZnNiTiO₄ | DLC | 4.E+04 | 1.E+07 |
| experimental | memory | | | | | | | |
| example | | | | | | | | |
| Ninth | Probe | CeO₂ | TiN | amo-B | ZnNiTiO₄ | DLC | 2.E+04 | 1.E+07 |
| experimental | memory | | | | | | | |
| example | | | | | | | | |
| Tenth | Probe | CeO₂ | TiN | BN | ZnNiTiO₄ | DLC | 5.E+04 | 1.E+07 |
| experimental | memory | | | | | | | |
| example | | | | | | | | |
| Eleventh | Cross-point | CeO₂ | TiN | AIN | ZnNiTiO₄ | TiO₂ | 2.E+04 | 1.E+07 |
| experimental | type memory | | | | | | | |
| example | | | | | | | | |
| Twelfth | Cross-point | CeO₂ | TaN | TaON | ZnNiTiO₄ | TiO₂ | 2.E+04 | 1.E+07 |
| experimental | type memory | | | | | | | |
| example | | | | | | | | |
| First | Cross-point | CeO₂ | TiN | None | ZnNiTiO₄ | TiO₂ | 2.E+03 | 1.E+07 |
| comparative | type memory | | | | | | | |
| example | | | | | | | | |
| Second | Cross-point | CeO₂ | TiN | None | ZnNiTiO₄ | TiO₂/AIN | 3.E+03 | 1.E+04~1.E+05 |
| comparative | type memory | | | | | | | |
| example | | | | | | | | |
| Third | Cross-point | CeO₂ | TiN | None | ZnNiTiO₄ | TiO₂/TaON | 3.E+03 | 1.E+04~1.E+05 |
| comparative | type memory | | | | | | | |
| example | | | | | | | | |

### 6. Other

According to the invention, during the erasing operation, the region where the Joule heat is generated is optimized so as to be located in the recording layer. Therefore, the erasing operation can be performed with the extremely small power consumption.

Further, according to the invention, the heat generation is suppressed in the useless region, so that interference in the adjacent cell can be suppressed. As a result, the fairly high recording density can be realized.

The examples of the invention are not limited to the embodiment, but various modifications of each constituent can be made without departing from the scope of the invention. Various inventions can be made by an appropriate combination of plural constituents disclosed in the embodiment. For example, some constituents may be eliminated from all the constituents disclosed in the embodiment, or constituents of different embodiments may appropriately be combined.

The invention has a huge industrial merit as the next-generation technology that breaks through a wall of the recording density of the current nonvolatile memory.

What is claimed is:

1. An information recording and reproducing device, in which a first compound contained in a recording layer comprises a composite compound comprising two or more kinds of cationic elements, at least one of the two or more kinds of cationic elements is a transition element having a d orbit filled incompletely with electrons, a shortest distance between cationic elements adjacent to each other is 0.32 nm or less, and the recording layer has at least two values of a low-resistance state and a high-resistance state by a phase change,
the information recording and reproducing device comprising a resistive layer directly or indirectly added to the recording layer and having electric resistivity larger than electric resistivity in the low-resistance state of the recording layer.

2. The device of claim 1, wherein the electric resistivity of the resistive layer is larger than the electric resistivity of the recording layer by at least one order of magnitude.

3. The device of claim 1, wherein the electric resistivity of the resistive layer is larger than 1×10⁻³ Ωcm.

4. The device of claim 1, wherein the phase change of the recording layer is caused by application of a voltage.

5. The device of claim 4, wherein the resistive layer is disposed on a cathode side of the recording layer.

6. The device of claim 1, wherein a thickness of the resistive layer is 50 nm or less.

7. The device of claim 1, wherein a thickness of the resistive layer is 1 nm or more and 2 nm or less.

8. The device of claim 1, wherein the recording layer is made of a material in which the resistance change is not caused by pulse current, and a state of the recording layer is read by passing the pulse current through the recording layer.

9. The device of claim 1, further comprising a second compound comprising at least one kind of transition element and a vacant site in which one of the two or more kinds of cationic elements can be accommodated, the second compound being in contact with the first compound.

10. The device of claim 1, wherein the resistive layer is a compound represented by a chemical formula: AOₓN_{y}, where A is at least one element selected from the group consisting of B, C, Al, Y, Ln, Si, Ti, Zr, Hf, V, Nb, Ta, Cr, Mo, and W, Ln is a lanthanoid element, and a molar ratio satisfies 0≦x≦2.5 and 0.1<y≦2.

11. The device of claim 1, wherein the resistive layer is one of DLC (Diamond-Like Carbon), B₄C, and BN.

12. The device of claim 1, wherein the resistive layer is in an amorphous state.

13. The device of claim 1, wherein the resistive layer contains an F element of 10 ppm or more and 1000 ppm or less.

14. The device of claim 1, which constitutes one of a probe type solid-state memory and a cross-point type solid-state memory.
